(19) United States
(12) Patent Application Publication
(10) Pub. No.: US 2009/0060008 A1
(43) Pub. Date: Mar. 5, 2009

(54) SYSTEM AND METHOD FOR BLIND SOURCE SEPARATION OF SIGNALS USING NOISE ESTIMATOR

(75) Inventor: Edward R. BEADLE, Melbourne, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 11/846,593

(22) Filed: Aug. 29, 2007

(51) Int. Cl. H04B 7/08; H04B 1/707; H04B 15/00

(52) U.S. Cl. 375/148; 702/191; 375/E01.002

(57) ABSTRACT

An array has Nₑₗ array elements for receiving a plurality of communication signals from different sources. A noise power estimator at each array element receives a signal and estimates the noise power by collecting Nₛ data samples, forming a covariance matrix of the Nₛ data samples based on a model order estimate, computing the eigenvalue decomposition of the covariance matrix and ranking eigenvalues from the minimum to the maximum for the determining the noise power of the received signal at the respective array element. A pencil-based blind source separation (BSS) processor receives the signals and noise estimates from each array element and noise power estimator and removes the noise.

### FIELD OF THE INVENTION

The present invention relates to receiving systems suitable for communications, and more particularly, this invention relates to the reception and blind sorting of a linearly mixed multi-signal environment using a novel method of noise sub-space removal to effect the source signal separation.

### BACKGROUND OF THE INVENTION

In many commercial or military receiving systems there is great advantage to achieving the capability to receive multiple co-channel (e.g. same frequency, polarization, and time of arrival) signals and being able to recover them uniquely nearly interference free. Typically this operation is achieved by exploiting the spatial diversity of the emitters in the environment and adaptively deriving “spatial filters” for each of the signals in the field of view of the sensing system. The “spatial filters” can be thought of as signal dependent beam patterns, where the processing in the receiving system is operative, for each signal, to place a beam on a signal and spatial nulls in the directions of all intereferers.

As is well known in the art, in all blind signal sorting algorithms the so-called noise sub-space must be removed prior to the computation of the spatial filtering. Otherwise, the spatial responses derived are biased and the desired level of nulling will not be achieved, and intolerable residual co-channel interference levels will result.

An example of a system for blind source signal separation is disclosed in commonly assigned U.S. Pat. No. 6,711,528, the disclosure which is hereby incorporated by reference in its entirety. This system uses a blind source separation and spatial fourth order cumulant matrix pencil, A blind source separation circuit uses fourth-order cumulants and a generalized eigenvalue analysis of the matrix pencil to separate blindly a linear mixture of unknown, statistically independent, and stationary narrowband signals at a low signal-to-noise plus interference ratio. The system separates signals and spatially and/or temporally correlated Gaussian noise, using an array of signal processor and blind source separation (BSS) processor incorporating a separation matrix calculation. It would be advantageous to provide “access” to individual signals with an improved signal and interference ratio prior to spatial filtering.

In the above system the noise subspace is eliminated by the mathematical properties of the cumulant operator. The limitation of that approach is the slow convergence of the cumulant operator. More effective means of using short time records are needed. One such method is disclosed herein, and affords the potential for the novelty of separating Nₑₗ signals with an array of Nₑₗ degree-of-freedom using only second-order statistics while not requiring array calibration. In additional each array port may have different noise powers and the array calibration need not be known a-priori. Prior art blind separation algorithms (e.g. MUSIC, ESPRIT) well-known in the art cannot provide all the previously novelties simultaneously.

### SUMMARY OF THE INVENTION

Blind Source Separation (BSS) processing of multiple signals can occur by exploiting second order statistics. A novelty of the current invention is that the system can separate up to Nₑₗ signals with an Nₑₗ degree of freedom (DOF) array without knowledge of the signals (e.g. temporal or spatial), no knowledge of receive array calibration, and using only second-order statistics. One essential element is the on-line adaptive noise estimation procedure set forth in copending U.S. patent application Ser. No. 11/845,186 filed Aug. 27, 2007, the disclosure which is hereby incorporated by reference in its entirety. The present invention, for the purpose of noise removal, treats each antenna element in the array as a scalar channel, and hence estimates the noise per channel which enables noise subspace removal in a preprocessing step. With these estimates, the vector channel processing (i.e. the array outputs) can be processed for the spatial filtering in a multi-signal environment to allow the system to provide “access” to individual signals with improved signal-to-interference ratio (SIR).

Throughout the disclosure the terms “communication signal” and “communications signals” are used as non-limiting examples. More generally any collection of 1 or more signals, wavefronts, or the like which may be used for communication, RADAR, remote sensing, or any other purpose could be substituted with equal efficacy.

The disclosed system is operative to receive and separate a plurality of communications signals transmitted over a communication channel from a plurality of sources. At the receiver is an array, and the array has Nₑₗ array elements for receiving the plurality of communications signals. The array elements need not be identical nor calibrated. A noise power estimator at each array element receives a (combined or mixed) signal from the respective array element and then estimates the noise power at the array element by collecting Nₛ data samples at the respective array element, forming a covariance matrix of the Nₛ data samples based on a model order estimate, computing the eigenvalue decomposition of the covariance matrix and ranking eigenvalues from the minimum to the maximum for the determining the noise power of the received signal at the respective array element. A pencil-based blind source separation (BSS) processor receives the signals and noise estimates from each array element and noise power estimator respectively, and removes the noise sub-space using specialized mathematical constructs of second-order statistics.

Each noise power estimator (i.e. Temporal Noise Power Estimator, FIG. 5, block 826) is operative for computing the noise contribution in each spatial degree of freedom of the array. Each noise power estimator is operative for individually estimating the model order based on a number to overbound a maximum possible number of possible individual signals in the sensed environment. FIG. 5 shows that each noise estimator is operative to make autonomous estimates of the environment model order, in practice it may be beneficial to allow communication between these processes so that one insures a common model order is used by all the processes.

A primary novelty of the invention is the blind separation of up to Nₑₗ signals with an Nₑₗ degree of freedom (DOF) array without knowledge of the signals (e.g. temporal or spatial), without knowledge of receive array calibration, and using only second-order statistics by preprocessing individual element data with an on-line adaptive noise estimation procedure.

### BRIEF DESCRIPTION OF THE DRAWINGS

Other objects, features and advantages of the present invention will become apparent from the detailed description of the invention which follows, when considered in light of the accompanying drawings in which:

FIG. 1 is block diagram of a noise estimator circuit operative for a blind noise estimation in a communications channel in accordance with a non-limiting example of the present invention.

FIG. 2 illustrates a covariance matrix of N data samples based on a model order selection using single channel data and showing eigenvalue calculations associated with true noise and associated signals.

FIG. 3 is a table showing sample run results and associated calculations in accordance with a non-limiting example of the present invention.

FIG. 4 is another fragmentary view of a communications system showing an N port (element) receiver array that communicates with N co-channel/co-polarized time coincident communication devices and illustrating when N signals should be separated with an N element array for blind source signal separation.

FIG. 5 is a block diagram showing an array of antenna and noise estimators of the type shown in FIG. 1, and a pencil-based second-order blind source separator (BSS) processor that is operative to remove the noise sub-base in the temporal domain prior to formation of a spatial matrix pencil to achieve maximal signal-to-interference (SIR) performance in accordance with a non-limiting example of the present invention.

FIGS. 6A, 6B and 6C are graphs showing sample results (i.e. adapted beam patterns with spatial nulls on interfering co-channel signals) for three sources (signals) and three sensors (elements) for the array at −10 degrees in FIG. 6A, 15 degrees in FIG. 6B, and 40 degrees in FIG. 6C as angle-of-arrival (AOA).

### DETAILED DESCRIPTION OF THE PREFERRED EMBODIMENTS

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art. Like numbers refer to like elements throughout.

It should be appreciated by one skilled in the art that the approach to be described is not limited to any particular communication standard (wireless or otherwise) and can be adapted for use with numerous wireless (or wired) communications standards such as Enhanced Data rates for GSM Evolution (EDGE), General Packet Radio Service (GPRS) or Enhanced GPRS (EGPRS), extended data rate Bluetooth, Wideband Code Division Multiple Access (WCDMA), Wireless LAN (WLAN), Ultra Wideband (UWB), coaxial cable, radar, optical, etc. Further, the invention is not limited for use with a specific PHY or radio type but is applicable to other compatible technologies as well.

Throughout this description, the term communications device is defined as any apparatus or mechanism adapted to transmit, receive or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof. Wireless communication involves: radio frequency communication; microwave communication, for example long-range line-of-sight via highly directional antennas, or short-range communication; and/or infrared (IR) short-range communication. Applications may involve point-to-point communication, point-to-multipoint communication, broadcasting, cellular networks and other wireless networks.

As will be appreciated by those skilled in the art, a method, data processing system, or computer program product can embody different examples in accordance with a non-limiting example of the present invention. Accordingly, these portions may take the form of an entirely hardware embodiment, an entirely software embodiment, or an embodiment combining software and hardware aspects. Furthermore, portions may be a computer program product on a computer-usable storage medium having computer readable program code on the medium. Any suitable computer readable medium may be utilized including, but not limited to, static and dynamic storage devices, hard disks, optical storage devices, and magnetic storage devices.

The description as presented below can apply with reference to flowchart illustrations of methods, systems, and computer program products according to an embodiment of the invention. It will be understood that blocks of the illustrations, and combinations of blocks in the illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions specified in the block or blocks.

These computer program instructions may also be stored in a computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

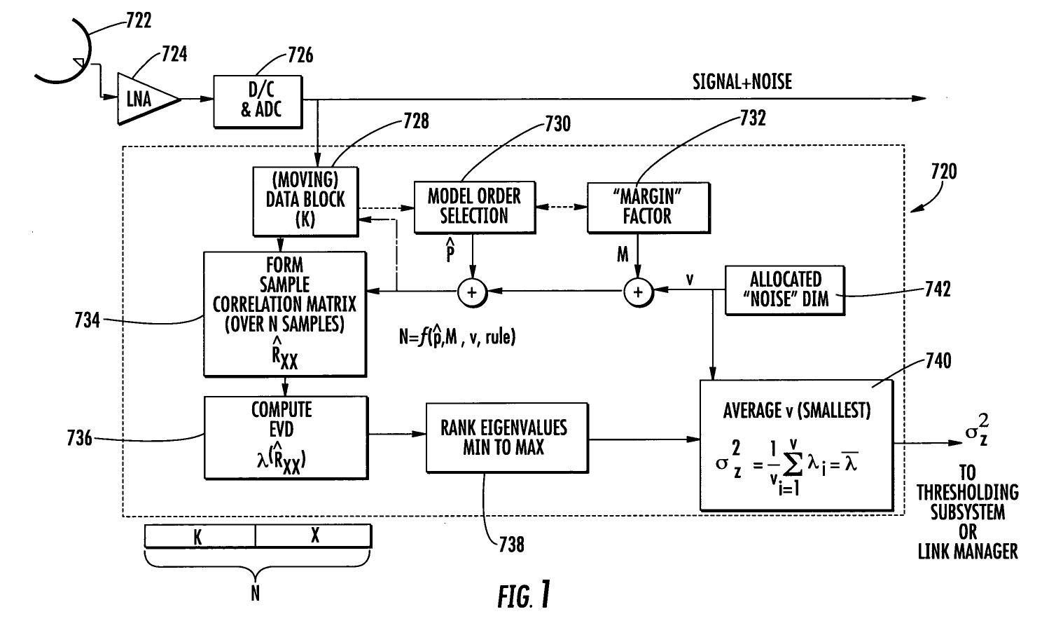

FIG. 1 is a block diagram illustrating at 720 a noise estimator that can be used with the blind source separation and showing circuit components operable on a data sample, for example, 10 microseconds of data per block. This noise estimator is used with the blind source separation of signals in accordance with a non-limiting example of the present invention.

The receiver antenna 722 is typically connected to a low noise amplifier (LNA) 724 for the purpose of low-level signal amplification of the radio-frequency (RF) signal. Following the typical RF reception circuitry is the down-converter (D/C) and analog-to-digital converter (ADC) notated as 726. The down-converter contains the circuitry typical of that to frequency shift, amplify and filter a band of frequencies for proper digitization as is well known to those skilled in the art. The analog/digital converter 726 operates at an appropriate intermediate frequency (IF) input frequency in typical non-limiting examples and has appropriate bit resolution for the system under consideration.

The output of the data-converter is labeled as “signal and noise” 727. This signal is processed by the noise estimation block 720 is detailed in FIG. 1. As shown in FIG. 1, a sequence of Nₛ digitizer outputs (i.e., ADC) is blocked into two consecutive blocks, respectively of size K and size X such that K+X=Nₛ. Successive blocks of N data samples may be defined from no overlap to nearly complete overlap depending on the specific application and designers discretion. While it is the intention to perform the processing described below on contiguous blocks of N sample, it is also conceivable that a system designer may wish to conserve processing resources and hence “sparsely” estimate the noise background. In this case the blocks of Nₛ samples may be taken somewhat “at will” and collected at scheduled or random intervals according to some application dependent rule.

Provision is also allowed for the data blocks to be of non-uniform size. Since as the system explores the signal environment it is reasonable to expect that Nₛ could be block adaptive. Smaller Nₛ allows faster adaptation to changing environments and limits computation resources. Larger N improves the accuracy of the correlation matrix entries. The designer must balance the trade-space for successful individual applications.

Returning the data collection, a block of K samples is taken in sequence as a (moving) data block (K) 728, for example, K=100 or more samples. Another block of data samples will be taken, X, forming an Nₛ sample block. The K blocks can be treated as a training sample for a model order selection module 730 and “margin” factor module 732. The model order, pₑₛₜ, is selected at the module 730. The accuracy of the value pₑₛₜ is based on several factors, including the model order estimation rule chosen, expected SNR, signal types expected, how many signals may be expected, computational resources to allocate to the problem to name a few.

Acknowledging that model order selection is an estimation process, and as such, subject to a variety of statistical variation issues, a “margin factor” M is generated within module 732. Factors contributing to the selection of an appropriate “margin factor” are similar to those listed above. The “margin factor” M is added to the estimated model order to insure that the correlation matrix formed in 734 is of sufficient size to capture the signal+noise space, so that appending v columns is guaranteed to access the noise-only space. Equivalently the “margin factor” M is selected to insure the condition, M+pₑₛₜ−1>p. Also, M can be used to include a margin for multipath, intermodulations and harmonic components not captured in the true model order “p”.

The sample correlation (or covariance matrix Rxx) of the Nₛ data samples based on the model order selection using single channel data is calculated within the processor 734 using typical estimation methods. This matrix Rxx is a temporal covariance matrix of the Nₛ samples of data. A module 736, computes the usual eigenvalue decomposition of the correlation matrix. The eigenvalues are ranked (by size) from minimum to maximum value within a comparator module 738. In block 740 the smallest v eigenvalues are taken and allocated as a dimensions representative of the noise-only space in covariance matrix Rxx. This allocation is based on the pre-allocated “noise” dimension v from module 742. It should be understood that the covariance matrix dimension used in this processing is typically large, but is much less than the number of data samples (Nₛ). Hence the system is not computing a full covariance matrix that could be calculated given the totality of data collected (i.e. Nₛ samples). The covariance matrix computed is intended to be the smallest possible size consistent with providing the access to the noise estimates.

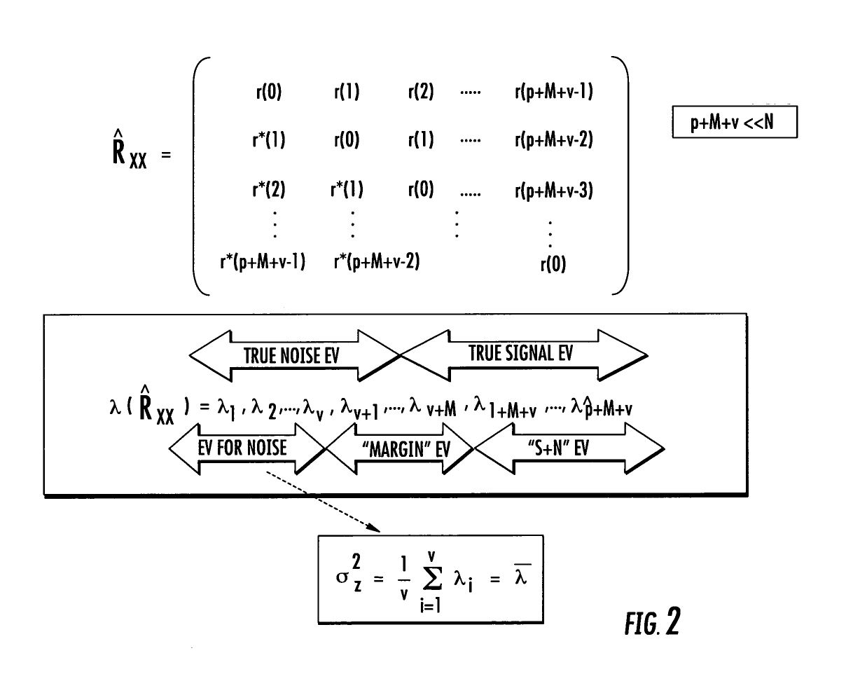

Returning to the eigenvalues of the correlation matrix, it should be understood that the trend that largest eigenvalues are representative of the true signals and the smallest eigenvalues are representative of the noise-only. The “v” smallest eigenvalues shown are in the noise dimension. As shown in the example covariance matrix Rxx and related calculations of FIG. 2, the v smallest eigenvalues are the desired eigenvalues for noise estimation. In principle v could be selected as small as 1, but experience has shown that due to statistical and numeric effects selecting v approximately equal to 3 produces good results and is robust over a variety of operating conditions.

The circuit as described for the noise estimator 720 forms an estimate of the noise floor (or total noise) in a band-of-interest while “contaminating” signals are (possibly) present. In this band-of-interest, there are an unknown, but bounded, number of communications signals, all of which may have unknown parameters (e.g., power, polarization, phase, etc.). The signals may also all have an individually set power. Usually, there is typically only a single temporal record of single channel data, i.e., the system is not considered an array processing problem, and instead is considered a blind noise estimation problem. The signals can be assumed to be stationary to at least a second order, i.e., WSS (wide-sense stationary) signals.

Depending on the signal models assumed to comprise the signal environment, numerous techniques for model order selection may be chosen. For example, suppose the technique Pisarenko Harmonic Decomposition (PHD) is chosen. This typically means that the system designer is willing to model the signal set as a set of sinusoids in white noise. For example, the data generation model could appear as:

$$x [ n ] = {\sum }_{i = 1}^{P} \sqrt{\frac{{P}_{t}}{2}} exp ( j 2 π {f}_{i} n ) + z [ n ]$$

where z [n] is complex Gaussian noise of zero mean and variance one (1), and the Pᵢ sets the power of each of the p complex sinusoids.

The estimation system block 720 (FIG. 1) may not know p a-priori, but when the estimation system processes the digitized data to achieve the noise estimate, however, this is not critical. The addition of the noise dimension v and margin M should allow “access” to noise only dimensions in the correlation matrix.

The processing system block 720 exploits the fact that it can form the sample temporal covariance matrix Rxx of suitable dimension (M+pₑₛₜ+v) by (M+pₑₛₜ+v) so that there are at least v eigenvalues (in principle) equal to the noise power.

In practice, there is a small spread of noise eigenvalues but this can be (at least partly) controlled by the data record length. Longer records, increased N, should improve the clustering of the noise eigenvalues. Also, assuming the system has a reasonable signal-to-noise ratio (SNR) (typically 3-6 dB), the noise eigenvalues should be fairly easily identified as the signal+noise space eigenvalues will be somewhat larger. Typically the larger the signal-to-noise ratio, the greater the distance. So, in applications with higher SNR, even some of the “margin factor” eigenvalues may be parsed into the noise dimension if desirable.

There now follows a sequence of steps that can be used for estimating the noise power in accordance with a non-limiting example of the present invention. Of course, different steps and intervening steps could be used, but the following illustration gives an overall methodology that could be modified or expanded as necessary.

Step 1. Estimate Model Order. Any model order estimation procedure could possibly be used to obtain an estimated model order and call it pest. Possible procedures include, but are not limited to, PHD, MUSIC, AR modeling, MDL, BIC, AIC or others.

Step 2. Form Sample Rxx (not full covariance matrix. The system typically requires a few extra columns more than the number of expected signals. The system selects “extra dimensions” (namely M and v). M, as mentioned above is selected to overbound the estimated model order, and v is selected to guarantee a certain number of noise-only dimensions. Good performance has been obtained with v=3 (assuming that p was well estimated). A limiting factor on selecting v is how many “similar” eigenvalues the system requires to be sure it has a repeated value different from the signal+noise space values. It is also desirable to limit v (and the “margin” M) to limit the computations required, since the system will require an full eigenvalue decomposition of larger and larger matrices as M, pₑₛₜ and v grow.

If the model order estimation technique is known or suspected to be biased low, the system designer will add some safety margin (in terms of extra “buffer” columns in the correlation matrix) and increase the size of the matrix Rxx. This is to insure separation of the p signal+noise and v noise-only eigenvalues. For example, the system can choose the dimension of Rxx as:

Dim=pₑₛₜ+abs(“maximum model order bias”)+v

Step 3. Compute Eigen Decomposition of Rxx. Compute the “traditional” Eigen decomposition of the matrix Rxx.

Step 4. Parse the Set of Eigenvalues into Noise-only and Non-Noise Only Spaces. The system starts with the smallest value. This may be close enough to the noise floor value to provide meaningful results in the applications. However, as a non-limiting example, a better approach is to use the v smallest Eigenvalues say by averaging them. Averaging will tend to reduce the variance of the noise estimate from selecting a single eigenvalue. Also, many other methods of processing a collection of statistics to refine a point estimate exists as well, such as using the median of the v smallest values. No one method is preferable in all cases.

Also, if still further refinement in the noise estimate, one could use more than the v smallest eigenvalues but then issues regarding where to “cut off” arise because there are Pest signals there is an added safety margin.

Optional Step 5. The system can increase the parameter v, and repeat the process to determine if a minimum Eigenvalue has remained about the same. This is simple without much added computation, since the system adds a single row and column to the already computed Rxx from the previous step. Hence, it is almost recursive.

For a two signal case (f=0.25 Fs, and 0.35 Fs, Fs is the ADC sampling frequency) with a signal-to-noise ratio of about 6 dB each and 1000 samples, the system in simulation obtained:

| v = 1, λ = 0.989, 1.8060, 12.216 | Noise power is 1.0 |
|---|---|
| v = 2, λ = 0.9645, 1.0549, 2.8632, 14.82 | Noise power = 1.0 (mean of |
| | 2 smallest values is |
| | 1.0097) |
| V = 3, λ = 0.885, 1.030, 1.099, 4.685, | Noise power = 1.0 (mean of |
| 18.226 | 3 smallest values is |
| | 1.0048) |

In one non-limiting example, the model order selection (as an estimate) can be based on use of a database of methods to operate on the data. Meaning that there can be a number of rules available “on demand” to select and refine the model order. The preferred embodiment uses data-based model order selection so the primary candidates of interest to most designers will be Multiple Signal Classifier (MUSIC) algorithm, Pisarenko Harmonic Decomposition (PHD), AIC, BIC, or MDL. Many other techniques known in engineering literature could be used. Data-based systems are preferred as they enable the system to adapt to changing signal environment conditions.

There are also non-data based methods such as simply selecting a “reasonable large number” to overbound the maximum number of possible individual signals on a transmitter but this is less attractive as the computations and data collection requirements will be fixed by a worst-case scenario which may infrequently, if ever, occur.

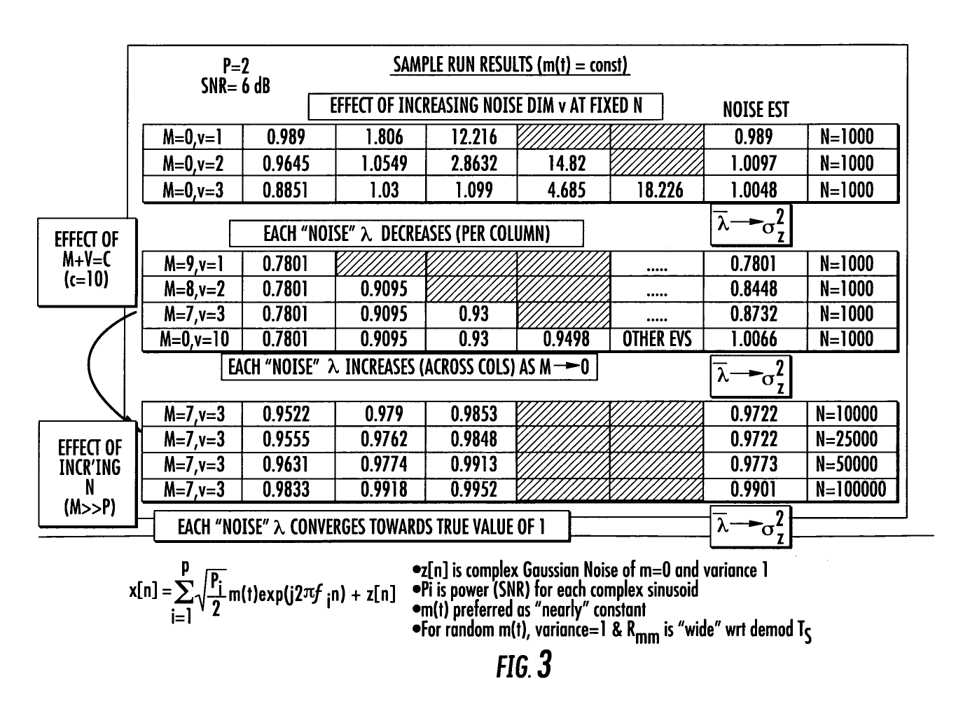

FIG. 3 is a table showing sample results. The columns 2-6 in the chart are the eigenvalues of the correlation matrix ranked in size order. The top block of data in the table shows an effect of the increase in the noise dimension “v” in the matrix at fixed N with two signals as “p”, (and “margin” M=0) and a signal-to-noise ratio of 6 dB. The noise dimension is increased to 1, 2 and 3 with p fixed at 2, M=0, and N is 1000 samples. In this case, we assumed a clairvoyant model order estimate (p=pₑₛₜ) to illustrate the effects of v. It is evident that as v is increased the average of the noise eigenvalues is getting closer and closer to the desired value (i.e., unity) of the truth in the simulation.

The second or middle part of the table shows the noise margin and subspace using two signals and sum of the “margin” M and noise dimension v are equal to 10. The margin decreases and noise dimension increases down the rows. In columns 2-5 the smallest v eigenvalues are shown (up to 4). Column 7 shows that the noise estimate from using the average of all v eigenvalues (some of which are not shown on the table for space reasons). In the case as v is increased the noise estimate (column 7) is highly accurate. However, in case of v=3 suitable accuracy for many application has been achieved. This table limited the data collection to N=1000 samples. Since the performance with v=3 is good for most practical situations a third table was generated hold M and v constant and increasing the number of samples per block.

The third or lower part of the table shows the effect of increasing Nₛ with M fixed at 7 and v=3. Note that as compared to the middle chart increasing Nₛ to at least 10000 samples has improved the noise estimate using v=3 smallest eigenvalues to nearly the ideal value of unity (with reference to row 3 of the middle table, labeled with M=7, v=3). Further increases of N provide only marginal improvements, and come at a cost of greatly increased processing to develop the sample estimates.

A result of the testing indicates that for “low” SNR (e.g. 3-6 dB) applications v should be set to nominally 3, N can be selected about 10000, and M can be safely selected nearly 4 times the expected true model order p.

In accordance with a non-limiting example of the present invention, blind source separation (BSS) processing of multiple signals in a scalar communications channel occurs by exploiting second order statistics and separating Nₑₗ signals with an Nₑₗ degree of freedom (DOF) array using the noise estimator for noise preprocessing as explained above. Spatial signal separation can occur by using the system set forth in the commonly assigned and incorporated by reference '528 patent. In accordance with a non-limiting example of the present invention, a scalar channel allows noise estimation and removal in a preprocessing step. The vector channel allows spatial filtering in a multi-signal environment. The system provides “access” to individual signals with improved signal-to-interference ratio (SIR) and cascades a noise removal preprocessing step prior to the spatial filtering.

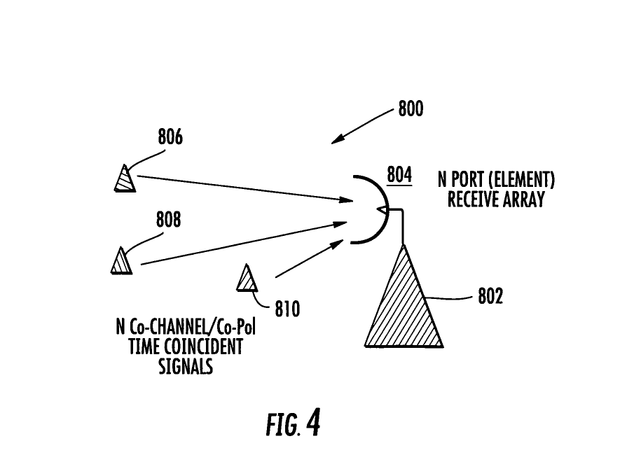

FIG. 4 is a fragmentary, diagrammatic view showing a communication system 800 with a receiver 802 as an N port (element) receiver array 804 and three radios 806, 808 and 810 as Nₑₗ co-channel and co-polarized, time coincident transmitted signals. In this blind source separation scenario shown in FIG. 4, each constituent signal in the environment could be isolated with no knowledge of the signals or parameters (such as QPSK or BPSK) and with potentially a negative signal-to-noise ratio in some non-limiting examples. There is typically no knowledge of the receiver array calibration except that there are Nₑₗ points or elements. There is typically no knowledge in the system of how it is calibrated. There is no prior knowledge of the number of signals, which can equal the number of array ports as points (or elements). The array can have different noise levels per receiver antenna port (element or point). Most second order techniques fail with these constraints and the system in accordance with a non-limiting example of the present invention provides a solution even with these constraints.

In accordance with a non-limiting example of the present invention, the noise sub-space is removed in the temporal domain prior to formation of a spatial matrix pencil for separation to achieve the maximum signal-to-interference performance. The result is that the pencil contains only the signal information in N_{sig}, where N_{sig} is the (a-priori unknown) number of signals in the environment non-zero Eigenvalues, and as a result, the orthogonality properties of the generalized Eigenvalue decomposition (GEVD) of the matrix pencil are exploited.

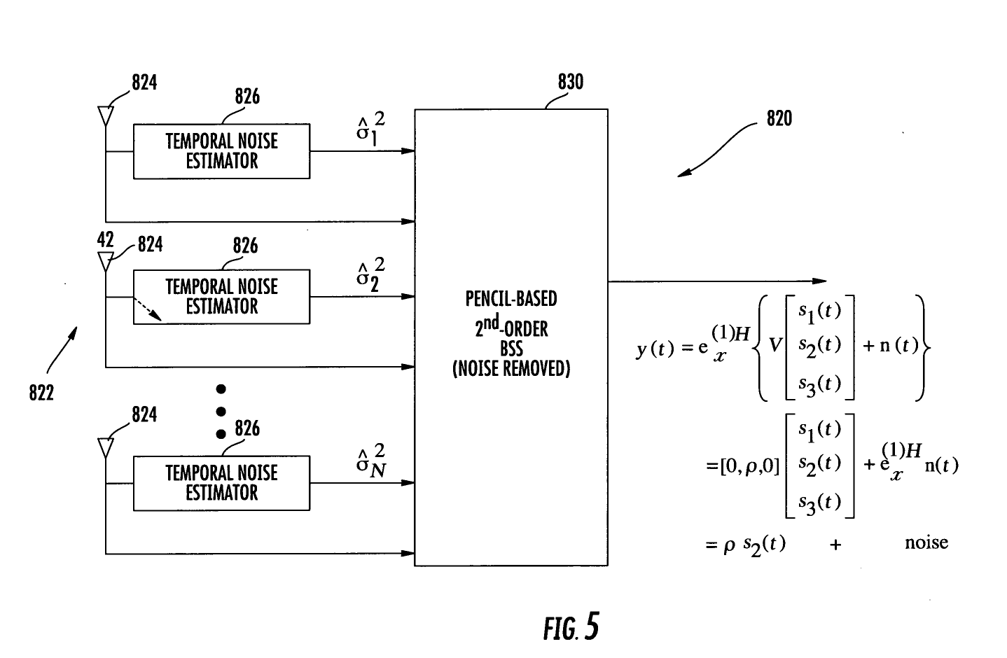

FIG. 5 is a block diagram of a portion of a receiver 820 as a system that can be used for blind source signal separation in accordance with a non-limiting example of the present invention. An antenna array 822 has illustrated array elements 824, The array elements 824 are not constrained in any way to be of uniform style, structure or construction. The only restriction imposed is that each array element provides a single wire interface (e.g. a scalar interface) for the temporal noise estimator. Thus in standard antenna terminology each array element 824 could be of the array 822 could be a single wire element (e.g. loop, whip, dipole) or a more complicated structure (e.g. direct radiating array) for sub-array combining, it is even possible within the current invention to have a heterogeneous mix of element types. But, no matter the sensing elements 824 are, each is connected to a temporal noise estimator 826 of the type as described above. Although three elements 824 are explicitly illustrated, the array could be larger or smaller.

Each noise estimator 826 outputs a value (i.e. the noise background estimated for the sensing element) into a first-order matrix pencil-based second-order blind source separation (BSS) processor 830. The BSS processor uses the collection of noise power estimates to remove the noise sub-space from the subsequent processing. Failure to remove the noise subspace significantly degrades the ability to reject interference using spatial filter as is well know in the art. The techniques used herein are similar to U.S. Pat. No. 6,711,528.

More specifically, similar to U.S. Pat. No. 6,711,528, the BSS system presented herein is capable of separating Nₑₗ signals using Nₑₗ signals sensors, however, unlike U.S. Pat. No. 6,711,528 the noise sub-space is removed prior to the BSS processing instead of as part of the process and uses second-order statistics in all the processing.

As mentioned before, U.S. Pat. No. 6,711,528 relies on higher-order statistics (i.e. fourth-order cumulants) where are slow to converge, hence second-order statistics offer must faster convergence properties. The direct benefit is smaller sample report is required to affect high quality separation.

In this disclosure, the matrices (to be discussed in detail below) are formed, either conceptually (e.g. such as when using the outputs of the noise estimators 826 and by inspection writing the desired form) or actually (e.g. such as when using the sensor 824 data directly and forming the needed mathematic operations per array snapshot). The system designer has complete freedom in ordering of the vector components, but a consistent method is required for all the signal and noise component throughout the process.

Each antenna port 824 uses the noise estimation procedure as described above and referenced and produces an estimate of the noise power in that channel. The BSS processor uses the resulting estimates from each channel and forms a diagonal noise correlation matrix Rₙₙ(0) The diagonal nature occurs due to an independence assumption on the noise processes in each array element channel. The independence assumption means that the noise in each array channel is jointly independent of the noise contributions in any other channel. This is a reasonable and common assumption in most standard array processing techniques. With this assumption, the resulting form of Rₙₙ(0) is Nₑₗ×Nₑₗ diagonal matrix with the Nₑₗ noise estimates populating the diagonal with 1 entry each. There is no preferred ordering of the elements to form the matrix, so any labeling (i.e. ordering) can be used, however, the ordering must be consistent throughout the process of forming all the matrices required for the process to insure consistent results.

An estimate of the lagged noise autocovariance Rₙₙ(t) is made. The value t is a selectable but fixed parameter and referred to as a lag value. The lag value is a relative time delay between the array samples used to form the covariance matrices. The matrix Rnn(t) is also diagonal and can be determined directly from the knowledge of the noise power per channel and the filter shapes for the signal path in each channel from well-known means.

The BSS processor 830 system computes the spatial covariance matrices using the array snapshot (denoted as a vector x and of dimension Nₑₗ×1) data from the sensors 824:

a) Compute Rₓₓ(0) using the array data yielding Rₓₓ(0)=VRₛₛ(0)V^{h}+Rₙₙ(0); and

b) Compute Rₓₓ(t) using the array data yielding Rₓₓ(t)=VRₛₛ(t)V^{h}+Rₙₙ(t). The system proceeds with a noise removal step and uses the Rnn's directly available by inspection and evaluates:

Rₓₓ(0)−Rₙₙ(0)=VRₛₛ(0)V^{h}; and a)

Rₓₓ(t)−Rₙₙ(t)=VR_{SS}(t)V^{h}. b)

Note that the quantities on the LHS of the above equations are available to the designer. The RHS quantities are not known nor available as they comprised of the correlation matrix (Rₛₛ) of the unknown signals and the unknown mixing of the signals, represented by the matrix V. In the above equations the symbol h or H stands for Hermitian transpose.

This subtraction is a key pre-processing step. The key is that, this step removes the effect of noise on all the RHS terms, such that if one only exploits various functions of the RHS the signal data can be recovered uniquely. A first order matrix pencil is one such mathematical structure.

The BSS system then processes data and performs the Generalized Eigenvalue Decomposition (GEVD) on the matrix pencil devoid of a noise subspace. To form the matrix pencil desired, multiple equation (b) by λ and take the difference of equation a and b to yield,

Pₓₓ=V(Rₛₛ(0)−λRₛₛ(t))V^{h}.

This solution has been addressed in the incorporated by reference U.S. Pat. No. 6,711,528.

The key properties of this pencil are that first, it has N_{sig} non-zero Eigenvalues. These correspond the signal content in a 1-1 fashion.

Secondly, the pencil has Nₑₗ−N_{sig} zero eigenvalues, which represents the array under-loading

The calculations for the system are addressed in more detail described below.

One prior art system also uses second order statistics and removed the noise subspace by subtraction. However, the prior art method requires that two non-zero lag values be chosen (where we chose a zero lag and 1 non-zero lag). The prior art requires that the two non-zero lags be restricted to that dictated by the zero crossings of the noise correlation function. The receiver filtering in turn sets this value. Thus the BSS processing algorithm of the prior art is directly impacted by the specific of the hardware design. In the present invention any value of lag variable may be chosen achieving the operational benefit of decoupling the algorithm performance and operation from hardware instantiation.

Returning the detailed discussion of the application, now assume with some ordering the array signal (vector) output x (i.e. a snapshot) at some time t is given by:

$$x ( t ) = {V}_{{↑}_{3 \times 3}} s {( t )}_{{↑}_{3 \times 1}} + n ( t )$$

V is the mixing matrix of the signals in the vector s and the additive noise is denoted by the vector n.

Using the array snapshots, the BSS processor 830 forms explicitly form the sample auto-correlations on a snapshot-by-snapshot basis. The sequence of autocorrelation matrices formed is recursively summed to produce a refined estimate of the true underlying statistical auto-correlation matrix. The individual snapshot correlation matrices form an approximation to underlying statistical quantities

Rₓₓ(0)=E{x(t)x^{H}(t)}=VRₛₛ(0)V^{H}=R_{NN}(0)

Rₓₓ(τ)=E{x(t)x^{H}(t+τ)}=VRₛₛ(τ)V^{H}=R_{NN}(τ)

Owing to the assumption of that the noise processes are independent channel-channel, but not temporally white yieldes:

R_{NN}(0)=diag(σ₁², σ₂², σ₃²)

R_{NN}(τ)=diag(σ₁²g₁(τ),σ₂²g₂(τ),σ₃²g₃(τ))

The functions g_{J} are known and reflect the filter shape of the receive channel. The three noise variances are estimated using the noise estimation technique described above and knowledge of the front-end filtering of the system disclosed. Thus the noise sub-spaces can be subtracted out directly yielding:

[Rₓₓ(0)−R_{NN}(0)]λ[Rₓₓ(τ)−R_{NN}(τ)]=V[Rₛₛ(0 )−λRₛₛ(τ)]V^{H}(**)

Because the noise contribution values are diagonal in the matrices, they are removed using the matrix pencil.

[Rₓₓ(0)−R_{NN}(0)]−λ[Rₓₓ(τ)−R_{NN}(τ)]=V[Rₛₛ(0)−λRₛₛ(τ)]V^{H}=P_{xx-NN}

Some properties can be exploited as follows. With independent signals, the matrices Rₛₛ (0) and Rₛₛ (τ) are diagonal, and can be solved using the techniques such as in the incorporated by reference U.S. Pat. No. 6,711,528 patent. The system uses the eigenvectors associated with N_{sig} non-zero Eigenvalues of the pencil (where the signal is located). Nₑₗ−N_{sig} zero Eigenvalues are dimensions not associated with the signal “point sub-space.” Information is carried in the pencil and the statistical property of the auto-correlation function and the matrix pencil is exploited to set the appropriate information and set weights on the array output.

The algorithm from the prior art patent forms a pencil using two “similar” matrices. The “similarity” is not the well-known mathematical similarity, but rather simply that they are similar in such a way that a common factorization can be applied to both matrices. The form of the equation below should be compared to (**) above. The same form means that the same processing can be used.

$$\begin{matrix}{P}_{x} ( λ , \overline{τ} ) ≡ {C}_{x}^{4} ( 0 , 0 , 0 ) - λ {C}_{x}^{4} ( {τ}_{1} , {τ}_{2} , {τ}_{3} ) \\ = V ( {C}_{τ}^{4} ( 0 , 0 , 0 ) - λ {C}_{τ}^{4} ( {τ}_{1} , {τ}_{2} , {τ}_{3} ) ) {V}^{H} \\ = V {P}_{τ} ( λ , \overline{τ} ) {V}^{H}\end{matrix}$$

The Eigenvalues and eigen vectors of theis pencil can be found using the Generalized Eigenvalue Decomposition (GEVD) as noted before. With signals from independent directors, V is full rank, leading to an “equivalence” between pencils Pₓ and Pᵣ, preserving the eigen structure of Pᵣ with a linear transform V.

$${e}_{x}^{{j}^{H}} V = {e}_{r}^{{j}^{H}}$$

Thus with M signals present, Pₓ inherits the M finite, non-zero eigenvalues from Pᵣ. The eigenvectors of Pₓ associated with the non-zero eigenvalues are applied the snapshots x from the array sensor outputs 824 to affect the separation of the signal environment.

$${e}_{x}^{{j}^{H}} x ( t ) = {e}_{x}^{{j}^{H}} V r ( t ) + {e}_{x}^{{j}^{H}} n ( t ) = {r}^{j} ( t ) + {e}_{x}^{{j}^{H}} n ( t )$$

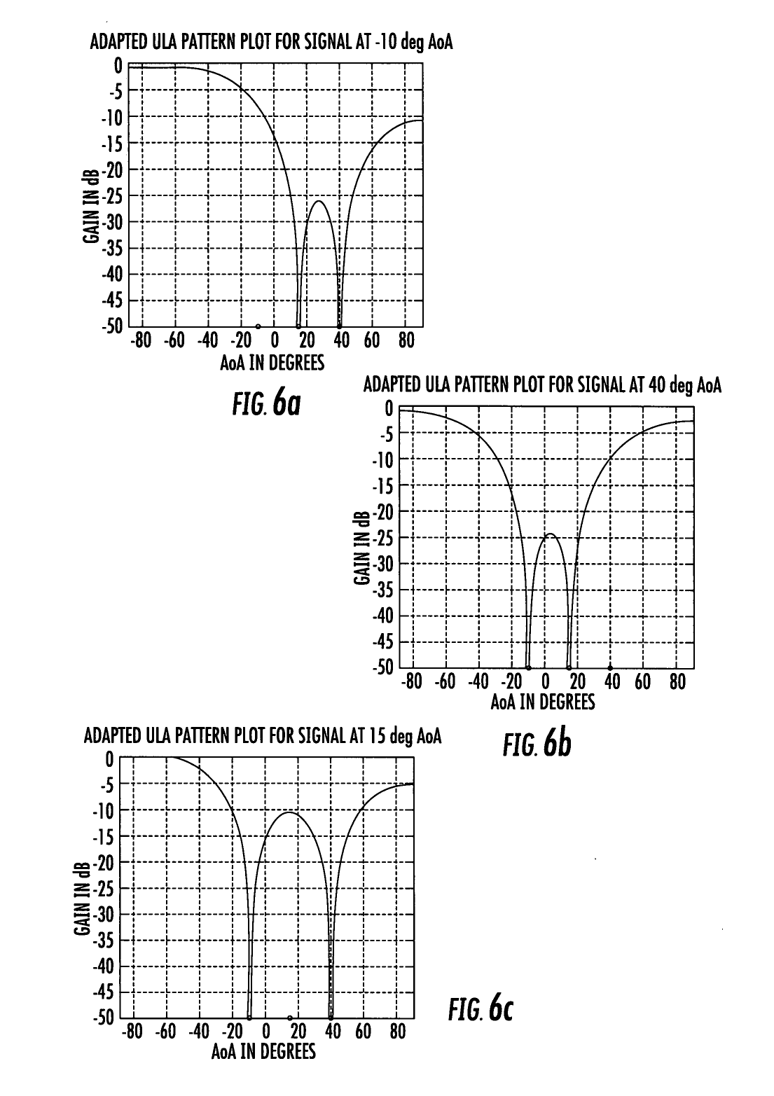

FIGS. 6A, 6B, and 6C show sample results for adapted patterns for three sources and three sensors from a uniform linear array as non-limiting examples and showing the signal at −15 degrees angle-of-arrival (AOA) in FIG. 6A, 10 degrees AOA in FIG. 6B, and 40 degrees AOA at FIG. 6C. The observations occur at about 6 dB signal-to-noise ratio with about 10,000 data samples which represent about 250 “symbols” of an unshaped BPSK (pi-polar phase shift keying) stream. The interferers are nulled by adapted patterns at −15, 10 and 40 degrees. The desired signal is shown with a beam shape “peak”. The estimated (true) channel noise values are 1.052 (1.00), 1.174 (1.15), and 1.275 (1.30) with the numerals in parenthesis corresponding to the true noise in each channel. The “quality” of the channel noise estimates depends somewhat on the signal-to-noise ratio as an absolute convergence of cross-terms below the true noise floor, which can be remedied by a larger sample support Nₛ (i.e. more array snapshots) and can be block recursive such that signal-to-noise ratio is traded for sample support. The patterns are not adapted with main beam constraints (e.g. peak gain of 0 dB in a desired direction), however this could be easily added.

The system provides for blind separation of Nₑₗ signals with Nₑₗ sensors (array) using second order statistics with access to the full degree of freedom (DoF) beyond the standard theoretical noise estimation techniques (e.g. MUSIC). Practical systems are generally limited to finding repeated or nearly repeated Eigenvalues, and thus, typical limits do not reach the theoretical number of signals, i.e., Nₑₗ−1.

The system can operate at a negative signal-to-noise ratio with a few and minor added assumptions, for example, requiring enough data to obtain the noise estimate. The values of p+M+v should be large enough such that accuracy of the noise estimate improves with data length and the number of dimensions are reserved per channel without impact to the array size. For example, an improved operation does not require additional spatial channels. Other techniques may require array channels in the spatial domain to obtain more Eigenvalues to average together and rid the system of noise. Further in the system disclosed the signals do not have to be Wide-Sense stationary (WSS) such that blocking of data for batch processing allows for non-WSS applications.

In summary, the system adds to the legacy of advanced array signal processing for fixed and mobile ad-hoc networks and supports automatic link establishment (ALE) and optical routing using in-service link quality measurements. As noted before, the system can be used for satellite communications, cellular and PCS communications in software defined radios by optimizing the link utility and resource allocation using in-service quality estimates such as the SNR, BER and Eb/No with appropriate power control, adaptive bit rate control, modulation selection, and fade protection. Adaptive beam forming can be used to allow an Nₑₗ port array to support end users and not be limited to at most Nₑₗ−1 users. The system can automatically adapt to time-varying noise and signal environments by repeating the separation process on blocked data.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A receiver for separating a plurality of communications signals transmitted over a communications channel from a plurality of sources, comprising:
an array having Nₑₗ array elements for receiving the plurality of communications signals;
a noise power estimator at each array element for receiving a signal from the respective array element and estimating the noise power at the array element by collecting N data samples at the respective array element, forming a covariance matrix of the Nₛ data samples based on a model order estimate, computing the eigenvalue decomposition of the covariance matrix and ranking resultant eigenvalues from the minimum to the maximum for determining the noise power of the received signal at the respective element; and
a pencil-based blind source separation (BSS) processor for receiving the signals and noise estimates from each array element and noise power estimator and removing the noise.

2. The receiver according to claim 1, wherein each noise power estimator is operative for computing the spatial covariances.

3. The receiver according to claim 1, wherein each noise power estimator is operative for estimating the model order based on a number to over bound a maximum possible number of possible individual signals from the transmitter.

4. The receiver according to claim 1, wherein each noise power estimator is operative for estimating the model order based on one of at least a Multiple Signal Classifier, Pisarenko Harmonic Decomposition, Auto-regression, Pade Approximation, Bayesian Information Criterion, Akaike's Information Criterion and Minimum Description Length algorithm.

5. The receiver according to claim 1, wherein each noise power estimator is operative for averaging the smallest eigenvalues for determining the noise power at each array element.

6. The receiver according to claim 1, wherein said BSS processor is operative for performing a Generalized Eigenvalue Decomposition (GEVD) of the pencil devoid of a noise subspace.

7. The receiver according to claim 1, wherein said BSS processor is operative for estimating a separation matrix as a function of a spatial second order cumulant matrix pencil.

8. A receiver for separating a plurality of communications signals transmitted over a communications channel from a plurality of sources, comprising:
an array having Nₑₗ elements for receiving the plurality of communications signals;
a noise power estimator at each array element for receiving a signal from the respective array element and estimating the noise power at the array element by collecting N data samples at the respective array element, forming a covariance matrix of the Nₛ data samples based on a model order estimate, computing the eigenvalue decomposition of the covariance matrix and ranking resultant eigenvalues from the minimum to the maximum for determining the noise power of the received signal at the respective array element;
a pencil-based blind source separation (BSS) processor for receiving the signals and noise estimates from each array element and noise power estimator and removing the noise; and
wherein said modulated signal comprises data and synchronization pulses and said receiver further comprises a first filter matched to a synchronization pulse, a second filter inversely matched to the synchronization pulse, a detector that determines the synchronization pulse based on outputs from the first and second filters, wherein said noise power estimator is coupled to the detector and estimates the noise power and sets a noise threshold based on the input signal using a covariance matrix that is formed of the Nₛ data samples based on the model order estimate.

9. The receiver according to claim 8, and further comprising an integrator coupled to an output of at least one of first and second filters for integrating samples accumulated by the first and second filters over N observation intervals.

10. The receiver according to claim 9, and further comprising a constant false alarm rate (CFAR) detector coupled to the noise power estimator and integrator for comparing samples to the noise threshold.

11. The receiver according to claim 10, wherein said first filter comprises a matched filter and said second filter comprises an orthogonal filter.

12. The receiver according to claim 8, wherein each noise power estimator is operative for computing the spatial covariances.

13. The receiver according to claim 8, wherein each noise power estimator is operative for estimating the model order based on a number to over bound a maximum possible number of possible individual signals from the transmitter.

14. The receiver according to claim 8, wherein each noise power estimator is operative for estimating the model order based on one of at least a Multiple Signal Classifier, Pisarenko Harmonic Decomposition, Auto-regression, Pade Approximation, Bayesian Information Criterion, Akaike's Information Criterion and Minimum Description Length algorithm.

15. The receiver according to claim 8, wherein each noise power estimator is operative for averaging the smallest eigenvalues for determining the noise power at each array element.

16. The receiver according to claim 8, wherein said BSS processor is operative for performing a Generalized Eigenvalue Decomposition (GEVD) of the pencil devoid of a noise subspace.

17. The receiver according to claim 8, wherein said BSS processor is operative for estimating a separation matrix as a function of a spatial second order cumulant matrix pencil.

18. A method for separating a plurality of communications signals transmitted over a communications channel from a plurality of sources, comprising:
receiving the communications signals within an array having Nₑₗ elements;
estimating the noise power at each of the Nₑₗ array elements by collecting Nₛ data samples at each array element, forming a covariance matrix of the Nₛ data samples based on a model order estimate, computing the eigenvalue decomposition of the covariance matrix and ranking resultant eigenvalues from the minimum to the maximum for determining the noise power of the received signal at each element; and
removing the noise within a pencil-based blind source separation processor.

19. The method according to claim 18, which further comprises computing the spatial covariances at each array element for removing the noise.

20. The method according to claim 18, which further comprises performing a Generalized Eigenvalue Decomposition (GEVD) of the pencil devoid of a noise subspace.

21. The method according to claim 18, which further comprises estimating a separation matrix as a function of a spatial second order cumulant matrix pencil.

22. The method according to claim 18, which further comprises forming the cumulant matrix pencil such that it contains signal information in non-zero eigenvalues.

23. The method according to claim 18, wherein the pencil has N_{sig} non-zero eigenvalues representing the signals.

24. The method according to claim 18, wherein the pencil has Nₑₗ-N_{sig} zero eigenvalues representing the array under loading.

25. The method according to claim 18, which further comprises using a temporal correlation within each array element to estimate the noise level per port of the array.
